(19) United States
(12) Patent Application Publication
(10) Pub. No.: US 2007/0275868 A1
(43) Pub. Date: Nov. 29, 2007

(54) Liquid detergent composition for improved grease cleaning

(76) Inventors: Steven Paul Georges Cooremans, Buggenhout (BE); Dieter Boeckh, Limburgerhof (DE); Arturo Luis Casado-Dominquez, Manheim (DE); Christian Bittner, Bensheim (DE); Andrea Margaret Misske, Speyer (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/805,207

(22) Filed: May 22, 2007

Related U.S. Application Data
(60) Provisional application No. 60/802,409, filed on May 22, 2006.

(51) Int. Cl. C11D 3/37

(52) U.S. Cl. 510/475; 510/506

(57) ABSTRACT

A liquid detergent composition having alkoxylated polyethyleneimine polymer and alkyl or hydroxyalkyl sulphate or sulphonate surfactants to provide improved grease cleaning.

### CROSS REFERENCE TO RELATED APPLICATION

This application claims the benefit of U.S. Provisional Application No. 60/802,409, filed May 22, 2006.

### FIELD OF INVENTION

The present invention relates to a liquid detergent composition comprising a alkoxylated polyethyleneimine polymer, amine oxide and a sulphate or sulphonate surfactant to provide improved grease cleaning from dish surfaces.

### BACKGROUND OF THE INVENTION

Grease cleaning with liquid detergents poses an ongoing problem for consumers. Consumers utilizing liquid detergent as a light-duty liquid dishwashing detergent composition tend to wash greasy, difficult to clean items at the end of their washing experience, after easier to clean items such as glasses and flatware are cleaned.

Light-duty liquid dishwashing detergent compositions require a high suds profile while providing grease cleaning. It has surprisingly been found that the present invention gives improved grease cleaning while maintaining acceptable levels of total amount of such cleaning and suds profile in a liquid dishwashing detergent composition.

### SUMMARY OF THE INVENTION

The present application relates to a liquid detergent composition comprising: (a) from about 0.1% to about 10% by weight of the composition of an alkoxylated polyethyleneimine polymer comprising a polyethyleneimine backbone having from about 400 to about 10000 weight average molecular weight and the alkoxylated polyethyleneiminie polymer further comprises: (1) one or two alkoxylation modifications per nitrogen atom by a polyalkoxylene chain having an average of about 1 to about 30 alkoxy moieties per modification, wherein the terminal alkoxy moiety of the alkoxylation modification is capped with hydrogen, a C₁-C₄ alkyl or mixtures thereof; (2) a substitution of one C₁-C₄ alkyl moiety and one or two alkoxylation modifications per nitrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof; and) b) from about 5% to about 40% by weight of the composition of a sulphate or sulphonate surfactant.

All documents cited are, in relevant part, incorporated herein by reference; the citation of any document is not to be construed as an admission that it is relevant art with respect to the present invention.

### DETAILED DESCRIPTION OF THE INVENTION

The liquid detergent compositions of the present invention surprisingly provide improved grease cleaning while maintaining acceptable levels of total amount of such cleaning and suds profile in a liquid dishwashing detergent composition.

As used herein “grease” means materials comprising at least in part (i.e., at least 0.5 wt % by weight of the grease) saturated and unsaturated fats and oils, preferably oils and fats derived from animal sources such as beef and/or chicken.

As used herein “suds profile” means amount of sudsing (high or low) and the persistence of sudsing (sustained or prevention) throughout the washing process resulting from the use of the liquid detergent composition of the present composition. Liquid dishwashing detergent compositions require high sudsing and sustained suds. This is particularly important with respect to liquid dishwashing detergent compositions as the consumer uses high sudsing as an indicator of the performance of the detergent composition. Moreover, the consumer in a liquid dishwashing detergent composition also uses the sudsing profile as an indicator that the wash solution still contains active detergent ingredients. The consumer usually renews the wash solution when the sudsing subsides. Thus, a low sudsing liquid dishwashing detergent composition formulation will tend to be replaced by the consumer more frequently than is necessary because of the low sudsing level.

As used herein “dish” means a surface such as dishes, glasses, pots, pans, baking dishes and flatware made from ceramic, china, metal, glass, plastic (polyethylene, polypropylene, polystyrene, etc.) and wood.

As used herein “light-duty liquid dishwashing detergent composition” refers to those compositions that are employed in manual (i.e. hand) dishwashing. Such compositions are generally high sudsing or foaming in nature.

Incorporated and included herein, as if expressly written herein, are all ranges of numbers when written in a “from X to Y” or “from about X to about Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Unless otherwise indicated, weight percentage is in reference to weight percentage of the liquid detergent composition. All temperatures, unless otherwise indicated are in Celsius.

Alkoxylated Polyethyleneimine Polymer

The present composition may comprise from about 0.01 wt % to about 2 wt %, preferably from about 0.1 wt % to about 1.5 wt %, more preferable from about 0.2% to about 1.5% by weight of the composition of an alkoxylated polyethyleneimine polymer.

The alkoxylated polyethyleneimine polymer of the present composition has a polyethyleneimine backbone having from about 400 to about 10000 weight average molecular weight, preferably from about 400 to about 7000 weight average molecular weight, alternatively from about 3000 to about 7000 weight average molecular weight.

The alkoxylation of the polyethyleneimine backbone includes: (1) one or two alkoxylation modifications per nitrogen atom, dependent on whether the modification occurs at a internal nitrogen atom or at an terminal nitrogen atom, in the polyethyleneimine backbone, the alkoxylation modification consisting of the replacement of a hydrogen atom on a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof, (2) a substitution of one C₁-C₄ alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof.

For example, but not limited to, below is shown possible modifications to terminal nitrogen atoms in the polyethyleneimine backbone where R represents an ethylene spacer and E represents a C₁-C₄ alkyl moiety and X⁻ represents a suitable water soluble counterion.

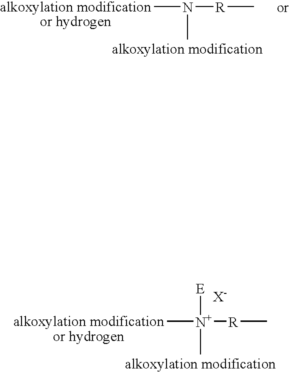

Also, for example, but not limited to, below is shown possible modifications to internal nitrogen atoms in the polyethyleneimine backbone where R represents an ethylene spacer and E represents a C₁-C₄ alkyl moiety and X⁻ represents a suitable water soluble counterion.

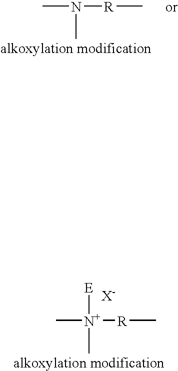

The alkoxylation modification of the polyethyleneimine backbone consists of the replacement of a hydrogen atom by a polyalkoxylene chain having an average of about 1 to about 30 alkoxy moieties, preferably from about 5 to about 20 alkoxy moieties. The alkoxy moieties are selected from ethoxy (EO), 1,2-propoxy (1,2-PO), 1,3-propoxy (1,3-PO), butoxy (BO), and combinations thereof. Preferably, the polyalkoxylene chain is selected from ethoxy moieties and ethoxy/propoxy block moieties. More preferably, the polyalkoxylene chain is ethoxy moieties in an average degree of from about 5 to about 15 and the polyalkoxylene chain is ethoxy/propoxy block moieties having an average degree of ethoxylation from about 5 to about 15 and an average degree of propoxylation from about 1 to about 16. Most preferable the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized.

A preferred modified polyethyleneimine has the general structure of formula (I): 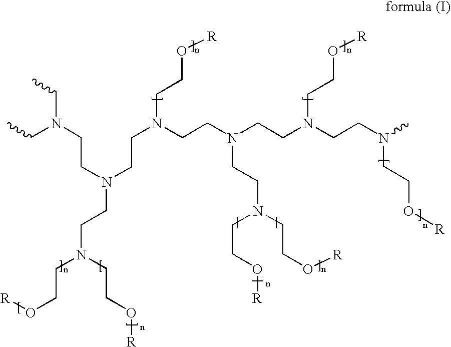
wherein the polyethyleneimine backbone has a weight average molecular weight of 600 or 5000, n of formula (I) has an average of 5-10 and R of formula (I) is selected from hydrogen, a C₁-C₄ alkyl and mixtures thereof.

Another preferred polyethyleneimine has the general structure of formula (II): 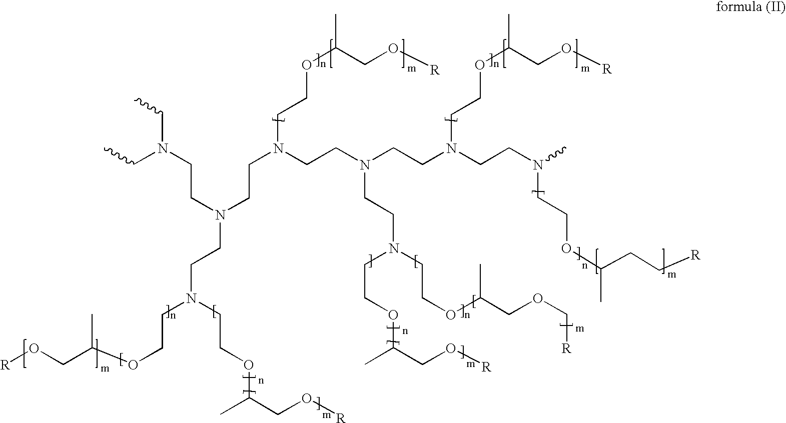
wherein the polyethyleneimine backbone has a weight average molecular weight of either 600 or 5000, n of formula (II) has an average of 10, m of formula (II) has an average of 7 and R of formula (II) is selected from hydrogen, a C₁-C₄ alkyl and mixtures thereof. The degree of permanent quaternization of formula (II) may be from 0% to about 22% of the polyethyleneimine backbone nitrogen atoms.

These polyamines can be prepared, for example, by polymerizing ethyleneimine in the presence of a catalyst such as carbon dioxide, sodium bisulfite, sulfuric acid, hydrogen peroxide, hydrochloric acid, acetic acid, and the like.

### EXAMPLE 1

### Polyethyleneimine (backbone molecular weight 5000) hereinafter PEI 5000 with 7 exthoxy moieties (EO) per nitrogen of the polyethyleneiminie backbone (NH)

a) Treatment of PEI 5000 with 1 EO/NH

Heat to 80° C. in a 2 L reactor 900 g of a 50 wt % aqueous solution of PEI 5000 (backbone molecular weight 5000) and strip with nitrogen thrice (until a pressure of 500 kPa (5 bar) is obtained). Increase the temperature to 90° C. and add 461 g ethylene oxide until pressure rises to 500 kPa (5 bar). Remove the volatile components after 2 hours by stripping with nitrogen at 80° C. or vacuum of 50 kPa (500 mbar) at 80° C. Collect 1345 g of a 68% aqueous solution, which contains PEI 5000 with 1 EO/NH

b) Alkoxylation in the Presence of a Solvent

Treat in a 2 l reactor 362 g of a 68.5% aqueous solution from step (a) with 31 g of 40% aqueous solution of potassium hydroxide and 300 g xylene and strip with nitrogen thrice (until a pressure of 500 kPa (5 bar) is obtained). Remove water during a 4 hour time period at 170° C. (under ascription of solvent). Add 753 g ethylene oxide at 120° C. until pressure of 300 kPa (3 bar) is obtained. Stir for 3 hours at 120° C. Remove the solvent from the compound and strip with a water steam at 120° C. for 3 hours. Collect 1000 g of a bright brownish viscous liquid (amine: 2.5448 mmol KOH/g; pH value 1% ig in water 11.2), which is the desired product (PEI 5000-7 EO/NH).

### EXAMPLE 2

### Polyethyleneimine (Backbone Molecular Weight 5000) Hereinafter PEI 5000 with 10 Exthoxy Moieties (EO) and 7 Propoxy Moieties (PO) Per Nitrogen of the Polyethyleneiminie Backbone (NH)

a) Treatment of PEI 5000 with 1 EO/NH as in Example 1.

b) Alkoxylation

Treat in a 2 l reactor 163 g of a 68.4% the aqueous solution from step (a) with 13.9 g of 40% an aqueous solution of potassium hydroxide, heat to 70° C. and strip with nitrogen thrice (until a pressure of 500 kPa (5 bar) is obtained). Remove water during a 4 hour time period at 120° C. and vacuum of 1 kPa (10 mbar). Add 506 g ethylene oxide at 120° C. until pressure of 800 kPa (8 bar) is obtained. Stir for 4 hours at 120° C. Strip with nitrogen 120° C. Add 519 g propylene oxide at 120° C. until pressure of 800 kPa (8 bar) is obtained. Stir for 4 hours at 102° C. Remove volatile components by stripping with nitrogen at 80° C. or vacuum of 50 kPa (500 mbar) at 80° C. Collect 1178 g of a bright brownish viscous liquid (amine titer: 0.9276 mmol KOH/g; pH value 1% ig in water 10.67), which is the desired product (PEI 5000-10 EO/NH—7 PO/NH).

OR

Alternative b) Alkoxylation in the Presence of a Solvent

Treat in a 2 l reactor 137 g of a 68.7% the aqueous solution from (a) with 11.8 g of 40% aqueous solution of potassium hydroxide and 300 g xylene and strip with nitrogen thrice (until pressure of 500 kPa (5 bar)). Remove the water present over the next 4 hours while maintaining a temperature of 170° C. (under ascription of solvent). Add 428 g of ethylene oxide at 120° C. until pressure of 300 kPa (3 bar) is obtained and stir for 2 hours at 120° C. Strip with nitrogen at 120° C. Add 439 g propylene oxide at 120° C. until pressure of 300 kPa (3 bar) is obtained. Stir for 3 hours at 120° C. Remove the solvent from the compound and strip with a water steam at 120° C. for 3 hours. Collect 956 g of a bright brownish viscous liquid (amine titer: 0.9672 mmol KOH/g; pH value 1% ig in water 10.69), which is the desired product (PEI 5000-10 EO/NH—7 PO/NH).

### EXAMPLE 3

### Polyethyleneimine (Backbone Molecular Weight 5000) Hereinafter PEI5000 with 10 Exthoxy Moieties (EO) and 7 Propoxy Moieties (PO) Per Nitrogen of the Polyethyleneiminie Backbone (NH) with 22% Quaternization

Prepare PEI 5000 EO10 PO7 as Shown in the Example 2

a) Quaternization

300 g of PEI5000-10 EO/NH—7 PO/NH (example 2) under nitrogen atmosphere were heated to 60° C. Subsequent 7.3 g dimethyl sulfate were dropwise added. Temperature rose to 70° C. and the mixture was stirred for 3 h. Reduction of amine titer (from 0.9672 mmol/g to 0.7514 mmol/g) showed a quaternation of 22% of N. 307 g of a brownish, viscous liquid are received, which is PEI 5000—(10 EO—7 PO)/NH—22% quatted.

### EXAMPLE 4

### Polyethyleneimine (Backbone Molecular Weight 600) Hereinafter PEI600 with 10 Exthoxy Moieties (EO) and 7 Propoxy Moieties (PO) Per Nitrogen of the Polyethyleneiminie Backbone (NH)

a) Treatment of PEI 600 with 1 EO/NH

In a 2 l reactor 516 g of polyethylene imine 600 (molecular weight 600 g/mol) and 10.3 g water were stripped with nitrogen thrice (until pressure of 5 bar) and heated to 90° C. At 90° C. 528 g ethylene oxide were added. After 1 h stirring at 90° C. 1050 g of a liquid are received. Volatile components are removed by stripping with nitrogen or vacuum of 10 mbar at 90° C. The liquid contains PEI 600 with 1 EO/NH.

b) Alkoxylation

In a 2 l reactor 86 g of a liquid from a) were treated with 10.8 g of 40% aqueous solution of KOH, heated to 80° C. and stripped with nitrogen thrice (until pressure of 5 bar). Water was removed during 2.5 h at 120° C. and vacuum of 10 mbar. Subsequent reactor was flushed with nitrogen and 384 g ethylene oxide were added at 120° C. and 2 h stirred at this temperature afterwards. Afterwards at 120° C. 393 g propylene oxide were added at 120° C. and 2 h stirred at this temperature. Volatile components are removed by stripping with nitrogen or vacuum of 500 mbar at 80° C. 865 g of a bright brownish viscous liquid are received (amine titer: 1.0137 mmol/g; pH value 1% ig in water 11.15), which is the desired product (PEI 600-10 EO/NH—7 PO/NH).

Aqueous Liquid Carrier

The liquid detergent compositions herein further contain from about 30% to about 80% of an aqueous liquid carrier in which the other essential and optional compositions components are dissolved, dispersed or suspended. More preferably the aqueous liquid carrier will comprise from about 45% to about 70%, more preferable from about 45% to about 65% of the compositions herein.

One preferred component of the aqueous liquid carrier is water. The aqueous liquid carrier, however, may contain other materials which are liquid, or which dissolve in the liquid carrier, at room temperature (20° C.-25° C.) and which may also serve some other function besides that of an inert filler. Such materials can include, for example, hydrotropes and solvents, discussed in more detail below. Dependent on the geography of use of the liquid detergent composition of the present invention, the water in the aqueous liquid carrier can have a hardness level of about 2-30 gpg (“gpg” is a measure of water hardness that is well known to those skilled in the art, and it stands for “grains per gallon”).

pH of the Composition

The liquid detergent composition may have any suitable pH. Preferably the pH of the composition is adjusted to between 4 and 14. More preferably the composition has pH of between 6 and 13, most preferably between 6 and 10. The pH of the composition can be adjusted using pH modifying ingredients known in the art.

Thickness of the Composition

The liquid detergent compositions of the present invention are preferably thickened and have viscosity of greater than 500 cps, when measured at 20° C. More preferably the viscosity of the composition is between 500 and 1100 cps. The present invention excludes compositions which are in the form of microemulsions.

Surfactants

The liquid detergent composition of the present invention may further comprise surfactants other than the mid-branched amine oxide discussed above, and are selected from nonionic, anionic, cationic surfactants, ampholytic, zwitterionic, semi-polar nonionic surfactants, and mixtures thereof. Optional surfactants, when present, may comprises from about 0.01% to about 50% by weight of the liquid detergent compositions of the present invention, preferably from about 1% to about 50% by weight of the liquid detergent composition. Non-limiting examples of optional surfactants are discussed below.

Anionic Surfactants

Sulphate or Sulphonate Surfactants

The sulphate or sulphonate surfactant is present at a level of at least 5%, more preferably from 5% to 40% and most preferably from 5% to 30% by weight of the liquid detergent composition.

Suitable sulphate or sulphonate surfactants for use in the compositions herein include water-soluble salts or acids of C₁₀-C₁₄ alkyl or hydroxyalkyl, sulphate or sulphonates. Suitable counterions include hydrogen, alkali metal cation or ammonium or substituted ammonium, but preferably sodium.

Where the hydrocarbyl chain is branched, it preferably comprises C₁₋₄ alkyl branching units. The average percentage branching of the sulphate or sulphonate surfactant is preferably greater than 30%, more preferably from 35% to 80% and most preferably from 40% to 60% of the total hydrocarbyl chains.

The sulphate or sulphonate surfactants may be selected from C₁₁-C₁₈ alkyl benzene sulphonates (LAS), C₈-C₂₀ primary, branched-chain and random alkyl sulphates (AS); C₁₀-C₁₈ secondary (2,3) alkyl sulfates; C₁₀-C₁₈ alkyl alkoxy sulfates (AEₓS) wherein preferably x is from 1-30; C₁₀-C₁₈ alkyl alkoxy carboxylates preferably comprising 1-5 ethoxy units; mid-chain branched alkyl sulphates as discussed in U.S. Pat. No. 6,020,303 and U.S. Pat. No. 6,060,443; mid-chain branched alkyl alkoxy sulphates as discussed in U.S. Pat. No. 6,008,181 and U.S. Pat. No. 6,020,303; modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS).

Alkyl glyceryl sulphonate surfactants and/or alkyl glyceryl sulphate surfactants generally used have high monomer content (greater than 60 wt % by weight of the alkyl glycerol sulphonate surfactant). As used herein “oligomer” includes dimer, trimer, quadrimer, and oligomers up to heptamers of alkyl glyceryl sulphonate surfactant and/or alkyl glyceryl sulphate surfactant. Minimization of the monomer content may be from 0 wt % to about 60 wt %, from 0 wt % to about 55 wt %, from 0 wt % to about 50 wt %, from 0 wt % to about 30 wt %, by weight of the alkyl glyceryl sulphonate surfactant and/or alkyl glyceryl sulphate surfactant present.

The alkyl glyceryl sulphonate surfactant and/or alkyl glyceryl sulphate surfactant for use herein include such surfactants having an alkyl chain length from C₁₀₋₄₀, C₁₀₋₂₂, C₁₂₋₁₈, and C₁₆₋₁₈. The alkyl chain may be branched or linear, wherein when present, the branches comprise a C₁₋₄ alkyl moiety, such as methyl (C₁) or ethyl (C₂). Generally, the structures of suitable alkyl glyceryl sulphonate surfactant oligomers that may be used herein include (A) dimers; (B) trimers, and (C) tetramers:

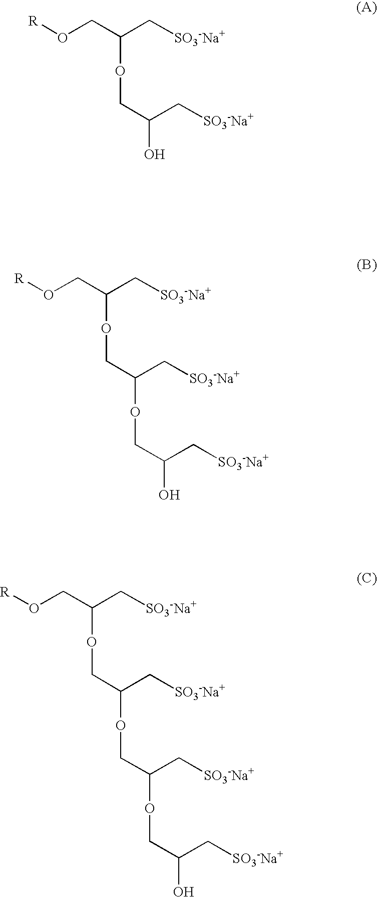

One of skill in the art will recognize that the counter-ion may be substituted with other suitable soluble cations other than the sodium shown above. R in the above structures (A)-(C) is from C₁₀₋₄₀, C₁₀₋₂₂, C₁₂₋₁₈, and C₁₆₋₁₈. The alkyl chain may be branched or linear, wherein when present, the branches comprise a C₁₋₄ alkyl moiety, such as methyl (C₁) or ethyl (C₂). One of skill in the art will also recognize that the corresponding alkyl glyceryl sulphate surfactant oligomers may also have similar structures with the SO₃⁻ moiety being an OSO₃⁻ moiety.

The alkyl glyceryl sulphonate surfactant and/or alkyl glyceryl sulphate surfactant oligomer content may be between about 40 wt % and 100 wt %, about 45 wt % and 100 wt %, about 50 wt % and 100 wt %, about 70 wt % and 100 wt % by weight of the alkyl glycerol sulphonate surfactant and/or alkyl glyceryl sulphate surfactant. As used herein, the “oligomer content” means the sum of the alkyl glyceryl sulphonate surfactant oligomers and/or alkyl glyceryl sulphate surfactant oligomers, such as dimers, trimers, quadrimers, and above (heptamers) present in the alkyl glyceryl sulphonate surfactant and/or alkyl glyceryl sulphate surfactant. More specifically, as shown below in Table I, nonlimiting examples of alkyl glyceryl sulphonate surfactant oligomer content demonstrates the weight percent of oligomers present and the minimization of the monomer content of the alkyl glyceryl sulphonate surfactant. The alkyl glyceryl sulphonate surfactant is optionally present at a level of at least 10%, more preferably from 10% to 40% and most preferably from 10% to 30% by weight of the composition.

Dialkylsulfosuccinates

An optional component used in the liquid detergent composition of the present invention is dialkyl sulfosuccinates. The dialkyl sulfosuccinates may be a C₆₋₁₅ linear or branched dialkyl sulfosuccinate. The alkyl moieties may be symmetrical (i.e., the same alkyl moieties) or asymmetrical (i.e., different alkyl moieties). Preferably, the alkyl moiety is symmetrical. The dialkyl sulfosuccinates may be present in the liquid detergent composition from about 0.5% to about 10% by weight of the composition.

Nonionic Surfactants

Nonionic surfactant, when present in the composition, is present in an effective amount, more preferably from 0.1% to 20%, by weight of the liquid detergent composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. Also suitable are alkylpolyglycosides having the formula R²O(CₙH₂ₙO)₁(glycosyl)ₓ (formula (III)), wherein R² of formula (III) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (III) is 2 or 3, preferably 2; t of formula (III) is from 0 to 10, preferably 0; and x of formula (III) is from 1.3 to 10, preferably from 1.3 to 3, most preferably from 1.3 to 2.7. The glycosyl is preferably derived from glucose.

Also suitable are fatty acid amide surfactants having the formula (IV): 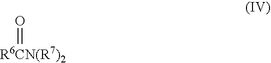
wherein R⁶ of formula (IV) is an alkyl group containing from 7 to 21, preferably from 9 to 17, carbon atoms and each R⁷ of formula (IV) is selected from the group consisting of hydrogen, C₁-C₄ alkyl, C₁-C₄ hydroxyalkyl, and —(C₂H₄O)ₓH where x of formula (IV) varies from 1 to 3. Preferred amides are C₈-C₂₀ ammonia amides, monoethanolamides, diethanolamides, and isopropanolamides.
Cationic Surfactants (Cationic surfactants, when present in the composition, is present in an effective amount, more preferably from 0.1% to 20%, by weight of the liquid detergent composition. Suitable cationic surfactants are quaternary ammonium surfactants. Suitable quaternary ammonium surfactants are selected from the group consisting of mono C₆-C₁₆, preferably C₆-C₁₀ N-alkyl or alkenyl ammonium surfactants, wherein the remaining N positions are substituted by methyl, hydroxyethyl or hydroxypropyl groups. Another preferred cationic surfactant is an C₆-C₁₈ alkyl or alkenyl ester of an quaternary ammonium alcohol, such as quaternary chlorine esters. More preferably, the cationic surfactants have the formula (V): 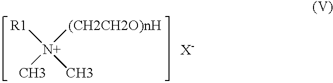
wherein R1 of formula (V) is C₈-C₁₈ hydrocarbyl and mixtures thereof, preferably, C₈₋₁₄ alkyl, more preferably, C₈, C₁₀ or C₁₂ alkyl, and X of formula (V) is an anion, preferably, chloride or bromide.
Amine Oxide surfactants

The liquid detergent compositions herein may comprise from about 0.1% to about 15% by weight of the liquid detergent composition of an amine oxide surfactant. The amine oxide may have a linear or mid-branched alkyl moiety.

Linear amine oxides, for optional use herein, include water-soluble amine oxides containing one C₈₋₁₈ alkyl moiety and 2 moieties selected from the group consisting of C₁₋₃ alkyl groups and C₁₋₃ hydroxyalkyl groups; water-soluble phosphine oxides containing one C₁₀₋₁₈ alkyl moiety and 2 moieties selected from the group consisting of C₁₋₃ alkyl groups and C₁₋₃ hydroxyalkyl groups; and water-soluble sulfoxides containing one C₁₀₋₁₈ alkyl moiety and a moiety selected from the group consisting of C₁₋₃ alkyl and C₁₋₃ hydroxyalkyl moieties.

Preferred amine oxide surfactants have formula (VI): 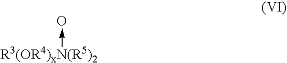
wherein R³ of formula (VI) is an linear C₈₋₂₂ alkyl, linear C₈₋₂₂ hydroxyalkyl, C₈₋₂₂ alkyl phenyl group, and mixtures thereof, R⁴ of formula (VI) is an C₂₋₃ alkylene or C₂₋₃ hydroxyalkylene group or mixtures thereof, x is from 0 to about 3; and each R⁵ of formula (VI) is an C₁₋₃ alkyl or C₁₋₃ hydroxyalkyl group or a polyethylene oxide group containing an average of from about 1 to about 3 ethylene oxide groups. The R⁵ groups of formula (VI) may be attached to each other, e.g., through an oxygen or nitrogen atom, to form a ring structure.

The linear amine oxide surfactants in particular may include linear C₁₀-C₁₈ alkyl dimethyl amine oxides and linear C₈-C₁₂ alkoxy ethyl dihydroxy ethyl amine oxides. Preferred amine oxides include linear C₁₀, linear C₁₀-C₁₂, and linear C₁₂-C₁₄ alkyl dimethyl amine oxides.

As used herein “mid-branched” means that the amine oxide has one alkyl moiety having n₁ carbon atoms with one alkyl branch on the alkyl moiety having n₂ carbon atoms. The alkyl branch is located on the a carbon from the nitrogen on the alkyl moiety. This type of branching for the amine oxide is also known in the art as an internal amine oxide. The total sum of n₁ and n₂ is from 10 to 24 carbon atoms, preferably from 12 to 20, and more preferably from 10 to 16. The number of carbon atoms for the one alkyl moiety (n₁) should be approximately the same number of carbon atoms as the one alkyl branch (n₂) such that the one alkyl moiety and the one alkyl branch are symmetric. As used herein “symmetric” means that |n₁−n₂ | is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C₁₋₃ alkyl, a C₁₋₃ hydroxyalkyl group, or a polyethylene oxide group containing an average of from about 1 to about 3 ethylene oxide groups. Preferably the two moieties are selected from a C₁₋₃ alkyl, more preferably both are selected as a C₁ alkyl.

Ampholytic Surfactants

Other suitable, non-limiting examples of amphoteric detergent surfactants that are optional in the present invention include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group. Typically, when present, ampholytic surfactants comprise from about 0.01% to about 20%, preferably from about 0.5% to about 10% by weight of the liquid detergent composition.

Magnesium Ions

The optional presence of magnesium ions may be utilized in the detergent composition when the compositions are used in softened water that contains few divalent ions. When utilized, the magnesium ions preferably are added as a hydroxide, chloride, acetate, sulfate, formate, oxide or nitrate salt to the compositions of the present invention. When included, the magnesium ions are present at an active level of from 0.01% to 1.5%, preferably from 0.015% to 1%, more preferably from 0.025% to 0.5%, by weight of the liquid detergent composition.

Solvent

The present compositions may optionally comprise a solvent. Suitable solvents include C₄₋₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof. When present, the liquid detergent composition will contain from about 0.01% to about 20%, preferably from about 0.5% to about 20%, more preferably from about 1% to about 10% by weight of the liquid detergent composition of a solvent. These solvents may be used in conjunction with an aqueous liquid carrier, such as water, or they may be used without any aqueous liquid carrier being present.

Hydrotrope

The liquid detergent compositions of the invention may optionally comprise a hydrotrope in an effective amount so that the liquid detergent compositions are appropriately compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, and related compounds, as disclosed in U.S. Pat. No. 3,915,903. The liquid detergent compositions of the present invention typically comprise from 0% to 15% by weight of the liquid detergent composition of a hydrotropic, or mixtures thereof, preferably from 1% to 10%, most preferably from 3% to 6% by weight.

Polymeric Suds Stabilizer

The compositions of the present invention may optionally contain a polymeric suds stabilizer. These polymeric suds stabilizers provide extended suds volume and suds duration of the liquid detergent compositions. These polymeric suds stabilizers may be selected from homopolymers of (N,N-dialkylamino) alkyl esters and (N,N-dialkylamino) alkyl acrylate esters. The weight average molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely the acrylate ester represented by the formula (VII):

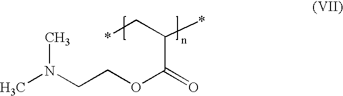

When present in the compositions, the polymeric suds booster may be present in the composition from 0.01% to 15%, preferably from 0.05% to 10%, more preferably from 0.1% to 5%, by weight of the liquid detergent composition.

Diamines

Another optional ingredient of the compositions according to the present invention is a diamine. Since the habits and practices of the users of liquid detergent compositions show considerable variation, the composition will preferably contain 0% to 15%, preferably 0.1% to 15%, preferably 0.2% to 10%, more preferably 0.25% to 6%, more preferably 0.5% to 1.5% by weight of said composition of at least one diamine.

Preferred organic diamines are those in which pK1 and pK2 are in the range of 8.0 to 11.5, preferably in the range of 8.4 to 11, even more preferably from 8.6 to 10.75. Preferred materials include 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (DYTEK EP®) (pK1=10.5; pK2=8.9), 2-methyl 1,5 pentane diamine (DYTEK AS) (pK1=11.2; pK2=10.0). Other preferred materials include primary/primary diamines with alkylene spacers ranging from C₄ to C₈. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by DUPONT®, a supplier of diamines. As a working definition herein, the pKa of the diamines is specified in an all-aqueous solution at 25° C. and for an ionic strength between 0.1 to 0.5 M.

Carboxylic Acid

The liquid detergent compositions according to the present invention may comprise a linear or cyclic carboxylic acid or salt thereof to improve the rinse feel of the composition. The presence of anionic surfactants, especially when present in higher amounts in the region of 15-35% by weight of the composition, results in the composition imparting a slippery feel to the hands of the user and the dishware. This feeling of slipperiness is reduced when using the carboxylic acids as defined herein i.e. the rinse feel becomes draggy.

Carboxylic acids useful herein include C₁₋₆ linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2,4 benzene tricarboxylic acid, pentanoic acid and salts thereof and mixtures thereof. Where the carboxylic acid exists in the salt form, the cation of the salt is preferably selected from alkali metal, alkaline earth metal, monoethanolamine, diethanolamine or triethanolamine and mixtures thereof.

The carboxylic acid or salt thereof, when present, is preferably present at the level of from 0.1% to 5%, more preferably from 0.2% to 1% and most preferably from 0.25% to 0.5%.

Preferably, the liquid detergent compositions herein are formulated as clear liquid compositions. By “clear” it is meant stable and transparent. In order to achieve clear compositions, the use of solvents and hydrotropes is well known to those familiar with the art of light-duty liquid dishwashing compositions. Preferred liquid detergent compositions in accordance with the invention are clear single phase liquids, but the invention also embraces clear and opaque products containing dispersed phases, such as beads or pearls as described in U.S. Pat. No. 5,866,529, to Erilli, et al., and U.S. Pat. No. 6,380,150, to Toussaint, et al., provided that such products are physically stable (i.e., do not separate) on storage.

The liquid detergent compositions of the present invention may be packages in any suitable packaging for delivering the liquid detergent composition for use. Preferably the package is a clear package made of glass or plastic.

Other Optional Components:

The liquid detergent compositions herein can further comprise a number of other optional ingredients suitable for use in liquid detergent compositions such as perfume, dyes, opacifiers, enzymes, chelants, thickening agents and pH buffering means so that the liquid detergent compositions herein generally have a pH of from 4 to 14, preferably 6 to 13, most preferably 6 to 10. A further discussion of acceptable optional ingredients suitable for use in light-duty liquid detergent composition may be found in U.S. Pat. No. 5,798,505.

Method of Use

In the method aspect of this invention, soiled dishes are contacted with an effective amount, typically from about 0.5 ml. to about 20 ml. (per 25 dishes being treated), preferably from about 3 ml. to about 10 ml., of the liquid detergent composition of the present invention diluted in water. The actual amount of liquid detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. The particular product formulation, in turn, will depend upon a number of factors, such as the intended market (i.e., U.S., Europe, Japan, etc.) for the composition product. Suitable examples may be seen below in Table I.

Generally, from about 0.01 ml. to about 150 ml., preferably from about 3 ml. to about 40 ml. of a liquid detergent composition of the invention is combined with from about 2000 ml. to about 20000 ml., more typically from about 5000 ml. to about 15000 ml. of water in a sink having a volumetric capacity in the range of from about 1000 ml. to about 20000 ml., more typically from about 5000 ml. to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of use will comprise immersing the soiled dishes into a water bath or held under running water without any liquid dishwashing detergent. A device for absorbing liquid dishwashing detergent, such as a sponge, is placed directly into a separate quantity of undiluted liquid dishwashing composition for a period of time typically ranging from about 1 to about 5 seconds. The absorbing device, and consequently the undiluted liquid dishwashing composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

Test Methods

Viscosity Test Method

The viscosity of the composition of the present invention is measured on a Brookfield viscometer model # LVDVII+ at 20° C. The spindle used for these measurements is S31 with the appropriate speed to measure products of different viscosities; e.g., 12 rpm to measure products of viscosity greater than 1000 cps; 30 rpm to measure products with viscosities between 500 cps-1000 cps; 60 rpm to measure products with viscosities less than 500 cps.

FORMULATION TABLE I
Light-Duty Liquid Dishwashing Detergent Composition

| | Composition | | | |
|---|---|---|---|---|
| | A | B | C | D |
| C₁₂₋₁₃ AE0.6S¹ | 29 | 26 | 26 | 26 |
| C₁₀₋₁₄ Amine Oxide | 6 | 6 | 6 | 6 |
| C₁₁E₉ Nonionic² | 2 | 2 | 2 | 2 |
| PLURONIC ®³ | 1 | 1 | 1 | 1 |
| Ethanol | 2.0 | 2.0 | 2.0 | 2.0 |
| alkoxylated polyethyleneimine | 0.1 | 0.5 | 1 | 2 |
| polymer⁴ | | | | |
| NaCl | 0.8 | 0.8 | 0.8 | 0.8 |
| 1,3 BAC Diamine⁵ | 0.2 | 0.2 | 0.2 | 0.2 |
| Suds boosting polymer⁶ | 0.1 | 0.1 | 0.1 | 0.1 |
| Water | Balance | Balance | Balance | Balance |

¹C₁₂₋₁₃ alkyl ethoxy sulfonate containing an average of 0.6 ethoxy groups.
²Nonionic may be either C₁₁ Alkyl ethoxylated surfactant containing 9 ethoxy groups.
³Poly(oxyethylene-oxypropylene-oxyethylene) ABA-type tri-block copolymer (e.g. PLURONIC L81 ® or PLURONIC L43 ®)
⁴Such as the ones exemplified in Examples 1-4 above
⁵1,3, BAC is 1,3 bis(methylamine)-cyclohexane.
⁶(N,N-dimethylamino)ethyl methacrylate homopolymer

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
a) from about 0.1% to about 10% by weight of the composition of an alkoxylated polyethyleneimine polymer comprising a polyethyleneimine backbone having from about 400 to about 10000 weight average molecular weight and the alkoxylated polyethyleneimine polymer further comprises:
(1) one or two alkoxylation modifications per nitrogen atom by a polyalkoxylene chain having an average of about 1 to about 30 alkoxy moieties per modification, wherein the terminal alkoxy moiety of the alkoxylation modification is capped with hydrogen, a C₁-C₄ alkyl or mixtures thereof;
(2) a substitution of one C₁-C₄ alkyl moiety and one or two alkoxylation modifications per nitrogen atom by a polyalkoxylene chain having an average of about 1 to about 40 alkoxy moieties per modification wherein the terminal alkoxy moiety is capped with hydrogen, a C₁-C₄ alkyl or mixtures thereof; or
(3) a combination thereof; and
b) from about 5% to about 40% by weight of the composition of a sulphate or sulphonate surfactant.

2. The liquid detergent composition according to claim 1 further comprising from 30% to 80% by weight of the liquid detergent composition of an aqueous liquid carrier.

3. The liquid detergent composition according to claim 1 wherein the sulfate or sulphonate surfactant is selected from linear alkyl sulphonate, fatty alcohol sulfate, alkyl alkoxylated sulfate, and mixtures thereof.

4. The liquid detergent composition according to claim 1 wherein the alkoxylation modifications are selected from ethoxy (EO), 1,2-propoxy (1,2-PO), 1,3-propoxy (1,3-PO), butoxy (BO), and combinations thereof.

5. The liquid detergent composition according to claim 1, wherein the alkoxylation modifications are selected from ethoxy moieties and ethoxy/propoxy block moieties.

6. The liquid detergent composition according to claim 1 wherein the alkoxylation modifications are ethoxy/propoxy block moieties having an average degree of ethoxylation from about 5 to about 15 and an average degree of propoxylation from about 1 to about 16.

7. The liquid detergent composition according to claim 1 further comprising from about 0.1% to about 15% by weight of the liquid detergent composition of an amine oxide.

8. The liquid detergent composition according to claim 1 wherein the composition further comprises from about 2% to about 5% by weight of the composition a C₆-C₁₄ linear or branched dialkyl sulfosuccinate.

9. The liquid detergent composition according to claim 1 further comprising from about 0.1% to about 20% by weight of the liquid detergent composition of a nonionic surfactant, cationic surfactant, or a mixture thereof.

10. The liquid detergent composition according to claim 9 wherein the nonionic surfactant selected from the group of C₈-C₂₂ aliphatic alcohols with 1 to 25 moles of ethylene oxide, alkylpolyglycosides, fatty acid amide surfactants, and mixtures thereof

11. The liquid detergent composition according to claim 1 further comprising from 0.01% to 20% by weight of the liquid detergent composition of a solvent and from 0% to about 15% by weight of the liquid detergent composition of a hydrotrope.

12. The liquid detergent composition according to claim 1 further comprising from about 0.01% to about 4% by weight of the liquid detergent composition of magnesium ions, from about 0.1% to about 15% by weight of the liquid detergent composition of a diamine, or mixtures thereof.

13. The liquid detergent composition according to claim 1 further comprising from about 0.01% to about 15% by weight of the liquid detergent composition of a suds boosting polymer, a polymeric suds stabilizer, or mixtures thereof.

14. A method of washing dishes with the liquid detergent composition according to claim 1, wherein 0.01 ml to 150 ml of said liquid detergent composition is diluted in 2000 ml to 20000 ml water, and the dishes are immersed in the diluted composition thus obtained and cleaned by contacting the soiled surface of the dish with a cloth, a sponge or a similar article.

15. A method of washing dishes, wherein the dishes are immersed in a water bath or held under running water and an effective amount of a liquid detergent composition according to claim 1 is absorbed onto a device, and the device with the absorbed liquid detergent composition is contacted individually to the surface of each of the soiled dishes.
